(19) United States
(12) Patent Application Publication
(10) Pub. No.: US 2015/0188449 A1
(43) Pub. Date: Jul. 2, 2015

(54) SWITCH FOR POWER SUPPLY CONTROL SYSTEM

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YI-LIANG LI, Wuhan (CN); GE HE, Wuhan (CN); YU-LIN LIU, Wuhan (CN)

(21) Appl. No.: 14/523,161

(22) Filed: Oct. 24, 2014

(30) Foreign Application Priority Data
Dec. 31, 2013 (CN) 201310750214.6

(51) Int. Cl. H02M 7/217

(52) U.S. Cl. CPC H02M 7/217

(57) ABSTRACT

A power supply control system includes a power supply, a transformer, a rectifier circuit, a comparison circuit, and a control circuit. An alternating power supply is configured to supply a first or a second providing voltage. The first or the second alternating voltage can be transformed to a first or a second direct voltage. The comparison circuit compares the first or the second direct voltage with a reference voltage. The comparison circuit outputs a first signal when the first or the second direct voltage is greater than the reference voltage. The control circuit controls the power supply to switch to a first location when receiving the first signal. The comparison circuit outputs a second signal when the first or the second direct voltage is less than the reference voltage. The control circuit controls the power supply to switch to a second location when receiving the second signal.

### CROSS-REFERENCE TO RELATED APPLICATIONS

This application claims priority to Chinese Patent Application No. 201310750214.6 filed Dec. 31, 2013, the contents of which are incorporated by reference herein.

### FIELD

The subject matter herein generally relates to a control system for controlling a power supply.

### BACKGROUND

A power supply control system is used for protecting a switch for power supply.

### BRIEF DESCRIPTION OF THE DRAWINGS

Implementations of the present technology will now be described, by way of example only, with reference to the attached figures.

FIG. 1 is a block diagram of one embodiment of a switch for power supply control system.

FIGS. 2 and 3 illustrate a circuit diagram of the control system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “comprising, but not necessarily limited to”; it specifically indicates open-ended inclusion or membership in the so-described combination, group, series and the like.

The present disclosure is described in relation to a control system for protecting a switch for power supply.

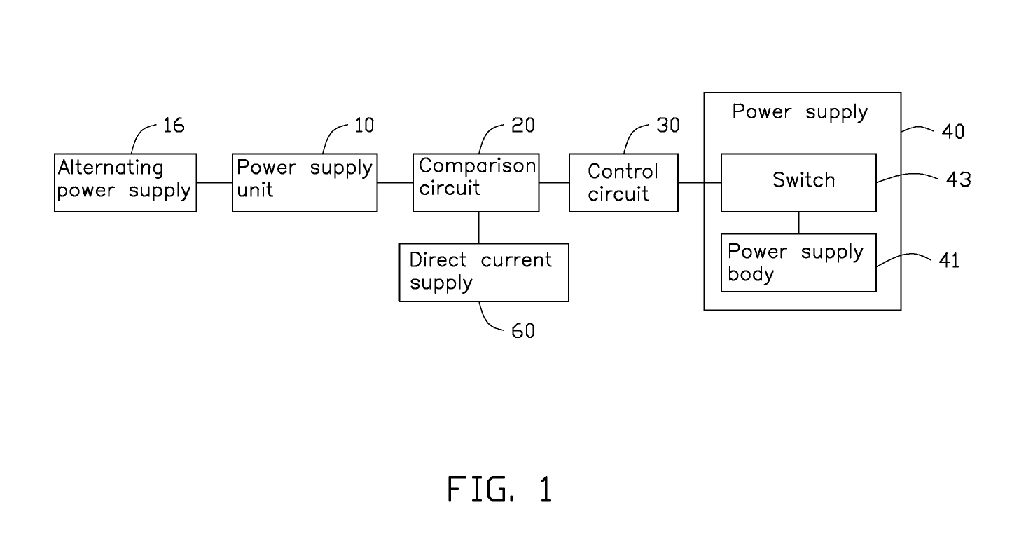

FIG. 1 illustrates an embodiment of a switch for power supply control system. The control system comprises a power supply unit 10, a comparison circuit 20 coupled to the power supply unit 10, a control circuit 30 coupled to the comparison circuit 20, and a power supply 40. The comparison circuit 20 is coupled to a direct current supply 60. The power supply 40 comprises a power supply body 41 and a switch 43 coupled to the power supply body 41. The power supply body 41 is configured to supply a first providing voltage when the switch 43 is switched in a first location and supply a second providing voltage when the switch 43 is switched in a second location. In at least one embodiment, the direct current supply 60 is configured to supply a voltage of 5V.

The power supply unit 10 is coupled to an alternating power supply 16. In at least one embodiment, the alternating power supply 16 is configured to supply a first alternating voltage of 220V or a second alternating voltage of 110V.

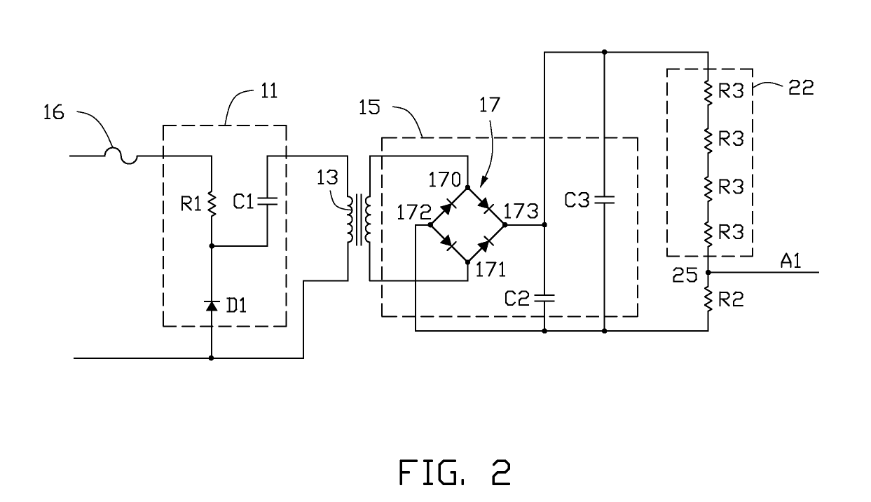

FIG. 2 illustrates that the power supply unit 10 comprises a filter circuit 11 coupled to the alternating power supply 16, a transformer 13 coupled to the filter circuit 11, and a rectifier circuit 15. The filter circuit 11 comprises a first resistor R1, a first capacitor C1, and a diode D1. The rectifier circuit 15 comprises a rectifier bridge 17 and a second capacitor C2. The rectifier bridge 17 comprises a first connecting end 170, a second connecting end 171, a third connecting end 172, and a fourth connecting end 173. The alternating power supply 16 is rectified to a direct current voltage via the transformer 13 and the rectifier circuit 15.

The comparison circuit 20 comprises a comparator 21, a divider resistor 22, and a sliding rheostat 23. The divider resistor 22 comprises four third resistors R3. The sliding rheostat 23 comprises a control pin 230, a first pin 232, and a second pin 234. In at least one embodiment, a type of the comparator 21 is LM293AN.

The control circuit 30 comprises a photo coupler 31, a transistor 33, and a controlling member 35. In at least one embodiment, the transistor 33 is a triode and a type of the transistor 33 is C9013; the controlling member 35 is a relay.

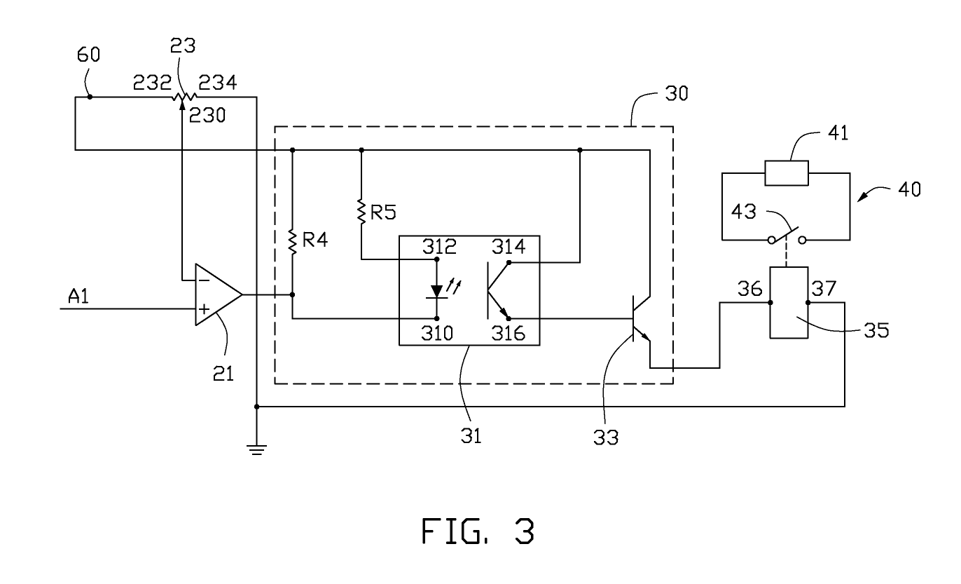

FIGS. 2 and 3 illustrate that the alternating power supply 16 is coupled to one end of the first resistor R1, the other end of the first resistor R1 is coupled to one input end (not labeled) of the transformer 13 via the first capacitor C1. The other end of the first resistor R1 is coupled to a cathode of the diode D1. An anode of the diode D1 is coupled to the other input end (not labeled) of the transformer 13. One output end (not labeled) of the transformer 13 is coupled to the first connecting end 170 of the rectifier bridge 17. The other output end (not labeled) of the transformer 13 is coupled to the second connecting end 171 of the rectifier bridge 17. The third connecting end 172 of the rectifier bridge 17 is coupled to the fourth connecting end 173 of the rectifier bridge 17 via the second capacitor C2. The third connecting end 172 of the rectifier bridge 17 is coupled to the fourth connecting end 173 of the rectifier bridge 17 via the third capacitor C3. The third connecting end 172 of the rectifier bridge 17 is coupled to a first node 25 via a second resistor R2. The fourth connecting end 173 of the rectifier bridge 17 is coupled to the first node 25 via the third resistors R3. The first node 25 is coupled to a positive input end (not labeled) of the comparator 21. A reverse input end (not labeled) of the comparator 21 is coupled to the control pin 230 of the sliding rheostat 23. The first connecting pin 232 of the sliding rheostat 23 is coupled to the direct current supply 60 and a second node 27. The second node 27 is coupled to a power supply pin (not labeled) of the comparator 21. A grounding pin (not labeled) of the comparator 21 is grounded.

An output pin (not labeled) of the comparator 21 is coupled to the second node 27 via a fourth resistor R4 and is coupled to one input end 310 of the photo coupler 31. The other input end 312 of the photo coupler 31 is coupled to the second node 27 via a fifth resistor R5. An output end 314 of the photo coupler 31 is coupled to the second node 27. The other output end 316 of the photo coupler 31 is coupled to a base of the transistor 33. A collector of the transistor 33 is coupled to the second node 27. An emitter of the transistor 33 is coupled to one terminal 36 of the controlling member 35. The other terminal 37 of controlling member 35 is grounded. The reverse input end of the comparator 21 receives a reference voltage from the sliding rheostat 23 and the direct current supply 60. In at least one embodiment, a resistance value of the first resistor R1 is 47 kilo-ohm (KΩ); a resistance value of the second resistor R2 and the third resistors R3 is 2 KΩ; a resistance value of the fourth resistor R4 is 5 KΩ; and a resistance value of the fifth resistor R5 is 1 KΩ.

The working principle of the control system is that the an alternating voltage of the alternating power supply 16 is changed to a direct current voltage via the transformer 13, the filter circuit 11, and the rectifier circuit 15. The direct current voltage is coupled to the positive input end of the comparison circuit 20. The comparator 21 compares the direct current voltage with the reference voltage. The comparator 21 outputs a high signal to the photo coupler 31 to switch on the photo coupler 31 after the direct current voltage is greater than the reference voltage. The transistor 33 is switched on after the photo coupler 31 is switched on. The controlling member 35 is switched on to control the switch 43 to be the first location after the transistor 33 is switched on. The comparator 21 outputs a low signal to the photo coupler 31 to switch off the photo coupler 31 after the direct current voltage is less than the reference voltage. The transistor 33 is switched off after the photo coupler 31 is switched off. The controlling member 35 is switched off to control the switch 43 to be the second location after the transistor 33 is switched off.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A power supply control system comprising:
a power supply;
a power supply unit having a transformer and a rectifier circuit;
a switch;
a comparison circuit; and
a control circuit,
wherein, an alternating power supply is configured to supply a first providing voltage when the switch is switched to a first location and a second providing voltage when the switch is switched to a second location;
the transformer and the rectifier circuit are configured to transform the first or the second alternating voltage to a first or a second direct voltage;
the comparison circuit is configured to compare the first direct voltage or the second direct voltage with a reference voltage, output a first signal when the first or the second direct voltage is great than the reference voltage, and output a second signal when the first or the second direct voltage is less than the reference voltage; and
the control circuit is further configured to control the power supply to switch to the first location when receiving the first signal and controls the power supply to switch to a second location when receiving the second signal.

2. The control system of claim 1, wherein the rectifier circuit comprises a rectifier bridge having a first connecting end, a second connecting end, a third connecting end, and a fourth connecting end; one output end of the transformer is coupled to the first connecting end of the rectifier bridge; the other output end of the transformer is coupled to the second connecting end of the rectifier bridge; the third connecting end and the fourth connecting end of the rectifier bridge are coupled to the comparison circuit to transmit the direct voltage to the comparison circuit.

3. The control system of claim 2, wherein a first capacitor is coupled between the third connecting end and the fourth connecting end of the rectifier bridge.

4. The control system of claim 2, wherein the comparison circuit comprises a comparator and a divider resistor, the divider resistor is coupled between the third connecting end and the fourth connecting end of the rectifier bridge, the comparator is coupled between a positive input pin of the comparator and the fourth connecting end of the rectifier bridge, and an output pin of the comparator is coupled to the control circuit.

5. The control system of claim 4, wherein a reverse input of the comparator is coupled to a power supply to receive the reference voltage.

6. The control system of claim 5, wherein the comparison circuit comprises a sliding rheostat having a control pin, a first pin, and a second pin; the control pin of the sliding rheostat is coupled to the reverse input of the comparator; the first pin of the sliding rheostat is coupled to a direct current supply; the second pin of the sliding rheostat is grounded; and the reference is formed from the direct current supply and the sliding rheostat.

7. The control system of claim 1, wherein the control circuit comprises a photo coupler coupled to the comparison circuit, a transistor coupled to the photo coupler, and a controlling member coupled to the transistor; the controlling member is coupled to the power supply; the photo coupler switches off the transistor when receiving the first signal and switches on the transistor when receiving the second signal; the controlling members is switched off after the transistor is switched off and switched on after the transistor is switched on; the power supply is in the first location after the controlling members is switched off and in the second location after the controlling members is switched on.

8. The control system of claim 1, wherein the power supply unit further comprises a filter circuit, the filter circuit comprises a first resistor, a first capacitor, and a diode; one end of the first resistor is coupled to the alternating power supply; the other end of the first resistor is coupled to one input end of the transformer via the first capacitor; the other end of the first resistor is coupled to a cathode of the diode; and an anode of the diode is coupled to the other input end of the transformer.

9. The control system of claim 1, wherein the transistor is a triode; one input end of the photo coupler is coupled to a collector of the transistor via a first resistor; one output end of the photo coupler is coupled to the collector of the transistor; the other output end of the photo coupler is coupled to a base of the transistor; an emitter of the transistor is coupled to the controlling member.

10. The control system of claim 9, wherein the other input end of the photo coupler is coupled to the collector of the transistor via a second resistor.

11. A power supply control system comprising:
a power supply;
a transformer;
a rectifier circuit;
a comparison circuit;
a control circuit; and
an alternating power supply,
wherein, the alternating power supply is configured to supply a first providing voltage when the switch is switched to a first location and a second providing voltage when the switch is switched to a second location;
the transformer and the rectifier circuit are configured to transform the first or the second alternating voltage to a first or a second direct voltage;
the comparison circuit is configured to compare the first direct voltage or the second direct voltage with a reference voltage output a first signal when the first or the second direct voltage is great than the reference voltage, and output a second signal when the first or the second direct voltage is less than the reference voltage; and
the control circuit is further configured to control the power supply to switch to the first location when receiving the first signal and controls the power supply to switch to a second location when receiving the second signal.

12. The control system of claim 11, further comprises a filter circuit, wherein the filter circuit comprises a first resistor, a first capacitor, and a diode; one end of the first resistor is coupled to the alternating power supply; the other end of the first resistor is coupled to one input end of the transformer via the first capacitor; the other end of the first resistor is coupled to a cathode of the diode; and an anode of the diode is coupled to the other input end of the transformer.

13. The control system of claim 11, wherein the rectifier circuit comprises a rectifier bridge having a first connecting end, a second connecting end, a third connecting end, and a fourth connecting end; one output end of the transformer is coupled to the first connecting end of the rectifier bridge; the other output end of the transformer is coupled to the second connecting end of the rectifier bridge; the third connecting end and the fourth connecting end of the rectifier bridge are coupled to the comparison circuit to transmit the direct voltage to the comparison circuit; and a first capacitor is coupled between the third connecting end and the fourth connecting end of the rectifier bridge.

14. The control system of claim 13, wherein the comparison circuit comprises a comparator and a divider resistor, the divider resistor is coupled between the third connecting end and the fourth connecting end of the rectifier bridge, the comparator is coupled between a positive input pin of the comparator and the fourth connecting end of the rectifier bridge, and an output pin of the comparator is coupled to the control circuit.

15. The control system of claim 14, wherein a reverse input of the comparator is coupled to a power supply to receive the reference voltage.

16. The control system of claim 15, wherein the comparison circuit comprises a sliding rheostat having a control pin, a first pin, and a second pin; the control pin of the sliding rheostat is coupled to the reverse input of the comparator; the first pin of the sliding rheostat is coupled to a direct current supply; the second pin of the sliding rheostat is grounded; and the reference is formed from the direct current supply and the sliding rheostat.

17. The control system of claim 11, wherein the control circuit comprises a photo coupler coupled to the comparison circuit, a transistor coupled to the photo coupler, and a controlling member coupled to the transistor; the controlling member is coupled to the power supply; the photo coupler switches off the transistor when receiving the first signal and switches on the transistor when receiving the second signal; the controlling members is switched off after the transistor is switched off and switched on after the transistor is switched on; the power supply is in the first location after the controlling members is switched off and in the second location after the controlling members is switched on.

18. The control system of claim 17, wherein the controlling member is a relay,

19. The control system of claim 11, wherein the transistor is a triode; one input end of the photo coupler is coupled to a collector of the transistor via a first resistor; one output end of the photo coupler is coupled to the collector of the transistor; the other output end of the photo coupler is coupled to a base of the transistor; an emitter of the transistor is coupled to the controlling member.

20. The control system of claim 19, wherein the other input end of the photo coupler is coupled to the collector of the transistor via a second resistor.
